(19) United States
(12) Patent Application Publication
(10) Pub. No.: US 2016/0210614 A1
(43) Pub. Date: Jul. 21, 2016

(54) AUTHENTICATION SYSTEM

(71) Applicant: Anthony Robert HALL, Luddington, North Lincolnshire (GB)

(72) Inventor: Anthony Robert Hall, Luddington (GB)

(21) Appl. No.: 14/914,051

(22) PCT Filed: Aug. 20, 2014
(86) PCT No.: PCT/GB2014/052559

§ 371 Date: Feb. 24, 2016

(30) Foreign Application Priority Data
Aug. 27, 2013 (GB) 1315237.6

(51) Int. Cl. G06Q 20/32; G06Q 20/36; G06Q 20/40; H04W 12/06

(52) U.S. Cl. CPC G06Q 20/3278; H04W 12/06; G06Q 20/3674; G06Q 20/401

(57) ABSTRACT

A system for authentication, the system comprising a wireless token (16), a user computer (12) and an authenticating computer (106), wherein the wireless token (16) is operable to provide authentication information to the user computer (12), the user computer (12) is operable to provide the authentication information to the authentication computer (106), and the authentication computer (106) is operable to authenticate the user computer (12) based on the authentication information.

### FIELD OF THE INVENTION

The invention relates generally to an authentication system and method and, more particularly, to an authentication system and method that enables a user to access a website, unlock, access or receive data, obtain goods/services, or activate goods/services, based on the presence of a token detected wirelessly.

### BACKGROUND OF THE INVENTION

It is known to provide credit for goods/services by means of a gift to another person. For example, a gift card may include a registration number, which is then entered into a suitable field on a website which will provide goods or services for the amount of credit specified by the card. A user must transfer the registration number from the gift card to a suitable field in the website to use the credit provided in the gift.

It is an object of some aspects of the present invention to address technical challenges resulting from the transfer of the registration number to the relevant website.

### STATEMENTS OF INVENTION

According to a first aspect of the present invention, there is provided a system for authentication, the system comprising a wireless token, a user computer and an authenticating computer, wherein the wireless token is operable to provide authentication information to the user computer, the user computer is operable to provide the authentication information to the authentication computer, and the authentication computer is operable to authenticate the user computer based on the authentication information.

For the avoidance of doubt, the term “computer” used herein is intended to cover all forms of computing device including, but not limited to, desktop and laptop computers, notebooks, tablets, smart phones, smart TVs, etc.

In an exemplary embodiment, the wireless token may have stored therein unique identifier data representative thereof. The authentication information may comprise or include said unique identifier data.

In one exemplary embodiment of the system, the wireless token may be configured to receive a signal from said user computer (for example, a payment station in a retail outlet), the wireless token being operable to provide the authentication information to the user computer only upon receipt of said signal. Then, when the user computer transmits the authentication information to a remote computer may be configured to return an activation code to the user computer, which activation code may be communicated to the wireless token, causing the product in which it is embedded, or with which it is associated, to be activated for use. Thus, for example, if the wireless token comprises a readable medium having recorded thereon media content, the wireless token may be configured to prevent the media content from being accessed unless and until it receives an activation code from the remote computer (via the user computer) indicating that the media content has been legitimately purchased.

In another exemplary embodiment of the invention, a wireless token may be purchased, either on its own or embedded or otherwise included in a toy or merchandise for example, wherein the token is enabled at the till, and digital A/V content, such as film or soundtrack, can then be accessed via the user computer from a remote location.

In another exemplary embodiment of the invention, the wireless token may be configured, in response to said activation code, to provide authentication information in the form of warranty data to the user computer, which can then be provided by the user computer to the authentication computer (administered, for example, by a manufacturer) as proof of purchase, for the purpose of validating and activating a manufacturer's warranty for an item within which said wireless token is embedded.

In yet another exemplary embodiment, the wireless token may be configured to receive and store data from the authentication computer (via a user computer). Thus, for example, a wireless token may be embedded in a child's toy for the purpose of facilitating a savings account. If a child wishes to put money in their account, they take the toy to the counter of the appropriate financial institution. The counter staff member uses the wireless token in the toy to wirelessly access the child's account on their counter computer upon receipt thereby of authentication information wirelessly transmitted from the token to the computer, and enters the amount of money received therein. The authentication information and data corresponding to the amount of money deposited is transmitted to a central computer and the child's balance updated. That updated balance data can then be sent back to the counter computer and, from there, transmitted back to the wireless token for local storage thereon. Then, if the child wishes, they can access their up-to-date balance information on their home computer using the wireless token system.

The wireless token may be operable to communicate with the user computer by means of a Bluetooth protocol, a Wi-Fi protocol or an RFID protocol. Other wireless communications techniques and protocols may be known to a person skilled in the art, and the present invention is not necessarily intended to be limited in this regard. However, in a preferred embodiment, and for security purposes, the wireless token may be operable to communicate with the user computer by means of a short range wireless protocol, and when proximate to the user computer. The proximate distance may be less than 4 m, or may be less than 3 m, or may be less than 2 m.

The wireless token may be embedded in, or comprise, an item that has a separate use for the user, for example, a gift or consumer item, which may be a toy, a casing for a product ,a readable medium, or an electrical item, for example.

The user computer may be operable to conduct automatic communication with the wireless token when the wireless token is within a predetermined range of the user computer. In this instance, within range means that the wireless token is within a range of operation of the wireless communication method used by the user computer and wireless token.

The communication between the user computer and the wireless token may be initiated when a user attempts to access a website, or other service having access controlled by the authentication computer. The authentication computer may be a plurality of interconnected computers that offer the web service or web site or goods/services as well as the authentication function mentioned above.

The user computer may be operable to store information about the wireless token for subsequent communication with the wireless token. Said subsequent communication may be automatic communication initiated when the wireless token is within range of the user computer.

The user computer may be operable to provide authentication information received from the wireless token to the authentication computer when the user attempts to access the website/web service with access controlled by the authentication computer. The provision of the authentication information may be in response to a request from the authentication computer.

The authentication computer may be, in use, remote from the user computer, with communication between the two optionally being by the internet.

The present invention extends to a wireless token for the authentication system described above, embedded in a toy, product or product casing.

According to another aspect of the present invention, there is provided an authentication method (optionally for authenticating a user to use a website or web service, or purchase goods or services from a website), the method comprising:

providing authentication information from a wireless token to a user computer, providing said authentication information from said user computer to an authentication computer, and authenticating the user computer based on said authentication information (optionally for requested access, if appropriate).

The present invention extends to one or more computer readable mediums having stored thereon one or more computer programs configured, when loaded onto respective one or more computers, in use, to perform the method defined above.

### BRIEF DESCRIPTION OF THE DRAWINGS

These and other aspects of the invention will be apparent from the following specific description in which embodiments of the present invention are described, by way of examples only, and with reference to the accompanying drawings, in which:

FIG. 1 is a schematic view of a gift containing a wireless token communicating with a desktop computer;

FIG. 2 is a schematic view of a wireless token permitting access into a concert, or other venue, in use; and

FIG. 3 is a schematic view of an authentication interaction between a music CD in a case carrying a wireless token and a desktop computer; and

FIG. 4 is a schematic block diagram illustrating an authentication system according to yet another exemplary embodiment of the present invention.

### DETAILED DESCRIPTION

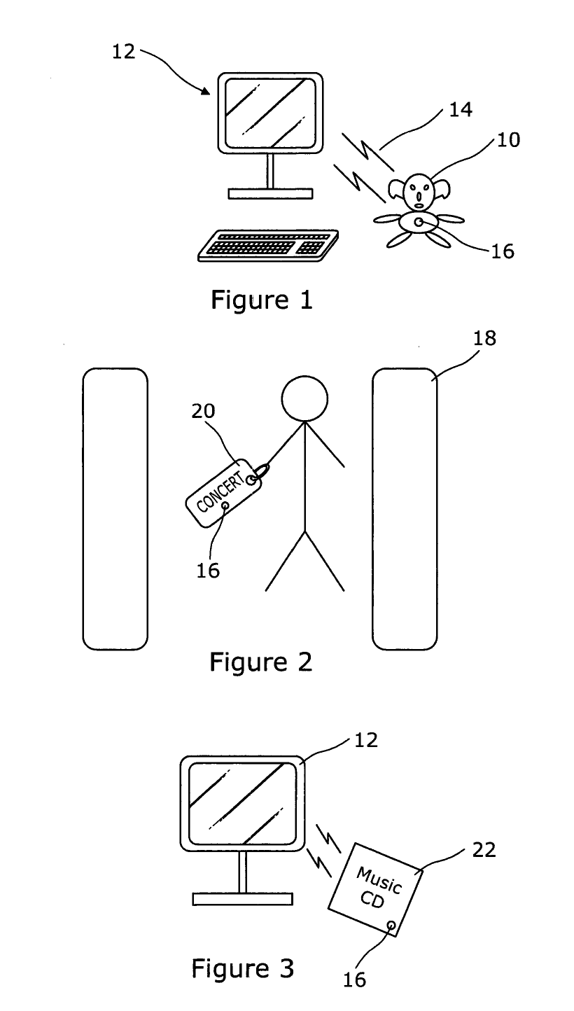

FIG. 1 shows a toy 10 that has been given as a gift to a user. The toy 10 is a toy that the user may wish to play with. In addition, however, the toy also incorporates an embedded wireless token 16 which is operable to interact by means of, for example, a Bluetooth communication protocol with a desktop computer 12. The wireless token 16 allows the user to access services or purchase products on a particular website to which the toy 10 with embedded wireless token 16 relates. The toy 10 can be provided as a gift to the user to allow the user to access the goods and services provided by the originator of the toy 10 and wireless token 16, wherein purchase of the toy 10 includes payment of a subscription (e.g. monthly) to the relevant website.

The wireless communication method mentioned above is referred to as a Bluetooth connection. However, the connection protocol could be a Wi-Fi connection according to one of the well known 802.11 protocols, or an RFID protocol where the wireless token 16 is, or includes, an RFID chip.

In use, a user may place the toy 10 in proximity to the computer 12 and access the website relevant to the toy by, for example, manually entering the website address into the address bar on the computer screen. Functionality of the relevant website allows a search function to be started to search for wireless tokens 16 in the proximity of the computer 12. The functionality of the website allows the control of, for example, Bluetooth communication hardware to scan for devices that can be paired, such as the wireless token 16. The usual handshake procedure is performed between the computer 12 and the wireless token 16 in the toy, as will be appreciated by a person skilled in the art. On completion of the handshake, the website interrogates the wireless token for authentication information relating thereto, in response to receipt of which the website provides credit to the user to allow services and/or goods to a value dictated by the wireless token 16. Similarly, when the value of goods/services has been obtained by the user, the database records for the website accessed by the user will be suitably updated to reflect that the wireless token no longer has remaining credit. Alternatively, the wireless token 16 may simply allow access to access-controlled parts of the website for a user to play games or interact with other users who are similarly authorised by other wireless tokens.

One option for functionality in relation to the wireless token 16 is to allow the desktop computer 12 to activate the website automatically on detection of a suitable token 16 in the proximity of the computer and to allow automatic access to the site by the user. In addition to value for the purchase of services and/or goods, the wireless token 16 may simply allow a registered user access to a particular website when the toy with its wireless token 16 is in the proximity of the computer 12. Indeed, in another embodiment, purchase of wireless tokens 16, or items including such tokens, could be used to pay for a subscription (e.g. monthly) to any type of website or, for example, an on-line magazine or newspaper.

The wireless token 16 and toy 10 may be used with different desktop computers (not shown), other than those first used by the user, with the toy 10, simply to allow access to the website referred to above by the user.

Wireless tokens 16 provided by a controller of the website are administered by means of a database of activated numbers that have been linked to wireless tokens 16, which database is checked whenever a wireless token is used to request access to the website and/or purchase goods/services as referred to above.

The handshake between the wireless token 16 and the computer 12 may require a user to register on the given website so that the user details are stored in conjunction with the wireless token details that are provided during the communication between the wireless token 16 and the computer 12 through to the website.

Once the user has first registered as associated with the wireless token 16 it is possible for the user to trade or transfer the toy with its wireless token 16 to another user registered with the website. The transfer is initiated by the first user who releases the wireless token 16 and hence the toy 10 to a second user.

FIG. 2 shows an alternative use of the wireless token 16 described above. In the embodiment shown in FIG. 2, a user gains access to a concert or similar event by means of a wireless token 16 allowing access through a control gate. Thus, for example, the user buys a “ticket” from a website for the concert or event, via their home computer. The central database associated with the concert tickets, transmits unique identification data to the user's home computer, which is then transmitted to the wireless token. When the user presents the wireless token at the control gate (including “the user computer”), the wireless token transmits the unique identification data via the control gate computer, to a central computer (“the authentication computer”), which checks the data against the central database for a match. If the wireless token identification data is deemed to be authorised, an authorisation signal is transmitted from the central computer to the control gate, which then allows the user to enter the venue.

Thus, instead of the usual concert ticket that is checked by a security guard, the user simply moves toward the control gate 18 and is allowed access through the gate if they are carrying a tag key fob 20 having a wireless token 16 embedded therein.

FIG. 3 shows a further embodiment in which the wireless token 16 can be used. In this embodiment, a music CD 22 (or other medium carrying A/V content) is purchased by a user in the usual way at a retail shop, by mail order, etc. The case of the music CD 22 includes the wireless token 16 embedded therein. On activation by a user, via the desktop computer 12, the user can be allowed to download the content of the music CD, in addition to being able to use the CD 22 as purchased.

The communication between the desktop computer 12 and the wireless token 16 is carried out in the same way as referred to above in relation to FIG. 1, by means of a handshake between the desktop computer 12 and the wireless token 16. The number of times a download may be carried out by the user is limited by the originator of the download via their website. In addition, the website logs the number of downloads that a user makes using the particular wireless token 16. The case of the CD 22 is another example of an article that a user may keep for other purposes, such as containing the CD, but in addition the object, in this example the case, has the functionality of allowing a user access to downloads, as mentioned above.

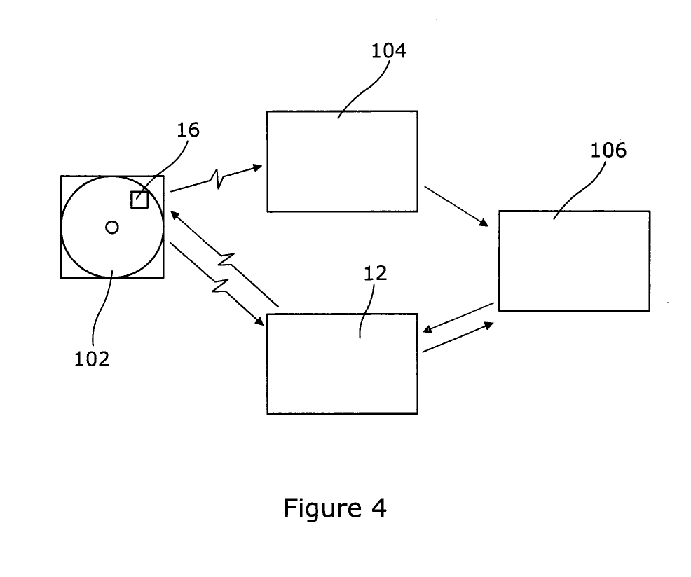

Referring to FIG. 4 of the drawings, in another exemplary embodiment, a system according to the invention can be employed to provide security for digital media, such as music or films, carried on a machine readable medium integrated within a wireless token, or stored remotely and accessible after purchase of a respective wireless token.

A wireless token 16 may be embedded in the machine readable medium, which may be in the form of a conventional disc 102 or may be in the form of a toy or other merchandise, for example. The disc 102 or toy may be provided in conventional packaging, on which is provided a barcode 103 or the like. The retailer scans the barcode 103 in the normal manner in order to enter sales information into the local payment station. The payment station 104 communicates data representative of the purchase to a central computer 106 (“the authentication computer”), so as to “activate” the purchase. When the user takes the item home and attempts to access the content thereon or stored remotely, via their smart TV, tablet, home computer, etc (“the user computer”) 12, the wireless token 16 communicates unique identification data corresponding to that item to the user computer 12, the user computer 12 communicates the data to the central computer 106 which checks the data against “activated” purchases and, if the item is determined thereby to have been legitimately purchased, returns an activation message to the user computer 12, allowing the content to be accessed.

In another exemplary embodiment of the invention, the wireless token may be configured, in response to said activation code, to provide authentication information in the form of warranty data to the payment station (“the user computer”) where the purchase is being made, which can then be provided by the user computer to a remote authentication computer (administered, for example, by a manufacturer) as proof of purchase, for the purpose of validating and activating a manufacturer's warranty for an item within which said wireless token is embedded.

In yet another exemplary embodiment, the wireless token may be configured to receive and store data returned from the authentication computer (via a user computer). Thus, for example, a wireless token may be embedded in a child's toy for the purpose of facilitating a savings account. If a child wishes to put money in their account, they take the toy to the counter of the appropriate financial institution. The counter staff member uses the wireless token in the toy to wirelessly access the child's account on their counter computer (“the user computer”) upon receipt thereby of authentication information wirelessly transmitted from the token to the computer, and enters the amount of money received therein. The authentication information and data corresponding to the amount of money deposited is transmitted to a central computer (“the authentication computer”) and the child's balance updated. That updated balance data can then be sent back to the counter computer and, from there, transmitted back to the wireless token for local storage thereon. Then, if the child wishes, they can access their up-to-date balance information on their home computer using the wireless token system.

It will be appreciated from the above that the embodiments described herein provide a wireless token 16 embedded in, or configured as, another object, which other object the user may wish to keep and use for other purposes than direct use of the wireless token 16. In these examples, there are the toy, the key fob 20, the music CD case 22, and the readable medium 102, which may carry any A/V media content. In alternative embodiments, the wireless token may be sold in isolation or as part of another item, such as film merchandise, whereby purchase of the token causes the token to be activated or validated at the point of purchase, thereby then enabling the user to access A/V digital content from a provider site, via their own computer. Allowing an automatic handshake between the wireless token 16 and a computer 12 provides additional advantages in relation to the transfer of information from the wireless token 16 to the provider of the token who will supply goods/services or access in return, based on the credit associated with the wireless token.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination of the features disclosed in this specification (including any accompanying claims, abstract and drawings), or to any novel one, or any novel combination, of the steps of any method or process so disclosed.

1-28. (canceled)

29. A system for authentication, the system comprising:
a wireless token,
a user computer and an authenticating computer,
wherein the wireless token is operable to provide authentication information to the user computer, the user computer is operable to provide the authentication information to the authentication computer, and the authentication computer is operable to authenticate the user computer based on the authentication information.

30. The system according to claim 29, wherein the wireless token has stored therein unique identifier data representative thereof.

31. The system according to claim 29, wherein said authentication computer is configured, upon receipt of said authentication information from said user computer, to return an activation code to the user computer, which activation code is communicated to the wireless token, causing an item with which it is associated, to be activated for use.

32. The system according to claim 29, wherein the wireless token is configured, in response to said activation code, to provide authentication information in the form of warranty data to the user computer, which is then provided by the user computer to the authentication computer as proof of purchase, for the purpose of validating and activating a manufacturer's warranty for an item with which said wireless token is associated.

33. The system according to claim 29, wherein the wireless token is configured to receive and store data from the authentication computer, via said user computer.

34. The system according to claim 29, wherein the wireless token is operable to communicate with the user computer by means of a Bluetooth protocol, a Wi-Fi protocol and/or an RFID protocol.

35. The system according to claim 29, the wireless token is operable to communicate with the user computer by means of a short range wireless protocol, and when proximate to the user computer.

36. The system according to claim 29, wherein the wireless token is embedded in an item that has a separate use for the user.

37. The system according to claim 36, wherein the wireless token is embedded in a gift or consumer item, or casing thereof.

38. The system according to claim 29, wherein the user computer is operable to conduct automatic communication with the wireless token when the wireless token is within a predetermined range of the user computer.

39. The system according to claim 29, wherein the communication between the user computer and the wireless token is initiated when a user attempts to access a website, or other service having access controlled by the authentication computer.

40. The system according to claim 29, wherein the authentication computer comprises a plurality of interconnected computers that offer a web service or web site or goods/services.

41. The system according to claim 29, wherein the user computer is operable to store information about the wireless token for subsequent communication with the wireless token.

42. The system according to claim 41, wherein said subsequent communication comprises automatic communication initiated when the wireless token is within range of the user computer.

43. The system according to claim 29, wherein the user computer is operable to provide authentication information received from the wireless token to the authentication computer when the user attempts to access a website/web service with access controlled by the authentication computer.

44. The system according to claim 29, wherein the authentication computer is, in use, remote from the user computer, with communication between the two being facilitated via the internet.

45. The wireless token for an authentication system according to claim 29, embedded in a toy, product or product casing.

46. The wireless token for an authentication system according to claim 29, comprising a readable medium on which is recorded media content.

47. An authentication method comprising
providing authentication information from a wireless token to a user computer,
providing said authentication information from said user computer to an authentication computer, and
authenticating the user computer based on said authentication information.

48. An authentication method for authenticating a user to use a website or web service, or purchase goods or services from a website, the method comprising:
providing authentication information from a wireless token to a user computer,
providing said authentication information from said user computer to an authentication computer, and
authenticating the user computer based on said authentication information for requested access, if appropriate.
